(19) United States
(12) Patent Application Publication
(10) Pub. No.: US 2021/0117647 A1
(43) Pub. Date: Apr. 22, 2021

(54) METHODS AND APPARATUSES FOR WAVE RECOGNITION, COMPUTER-READABLE STORAGE MEDIA, AND UNMANNED AERIAL VEHICLES

(71) Applicant: SZ DJI TECHNOLOGY CO., LTD., Shenzhen (CN)

(72) Inventors: Jianzhao CAI, Shenzhen (CN); You ZHOU, Shenzhen (CN); Weihong ZHENG, Shenzhen (CN)

(73) Assignee: SZ DJI TECHNOLOGY CO., LTD., Shenzhen (CN)

(21) Appl. No.: 17/110,310

(22) Filed: Dec. 3, 2020

Related U.S. Application Data
(63) Continuation of application No. PCT/CN2018/095655, filed on Jul. 13, 2018.

(51) Int. Cl. G06K 9/00; G06K 9/62; G06T 7/73; G06T 7/90; G06K 9/46; G06T 7/246; G06K 9/38; G06T 7/11; H04N 5/265; B64C 39/02; B64D 47/08; G05D 1/10

(52) U.S. Cl. CPC G06K 9/0063; G01S 19/42; G06T 7/74; G06T 7/90; G06K 9/4652; G06K 9/6215; G06T 7/248; G06K 9/4604; G06K 9/38; G06T 7/11; H04N 5/265; B64C 39/024; B64D 47/08; G05D 1/101; G06K 2009/6213; G06T 2207/30244; G06T 2207/10032; G06T 2207/30181; B64C 2201/127; G06K 9/6202

(57) ABSTRACT

The present disclosure discloses methods and apparatuses for wave recognition, and unmanned aerial vehicles. The method includes: extracting a first image acquired by an image acquisition apparatus at a first moment and a second image acquired by the image acquisition apparatus at a second moment; extracting a target region in each of the first image and the second image; comparing feature information of the target region in the first image with feature information of the target region in the second image; and determining whether the target region is a wave according to a result of the comparing of the feature information. The methods and apparatuses for wave recognition, and unmanned aerial vehicles recognize a wave in an image based on the change of feature information of a target region in the image at different times.

### RELATED APPLICATIONS

The present patent document is a continuation of PCT Application Serial No. PCT/CN2018/095655, filed on Jul. 13, 2018, designating the United States, published in Chinese, content of which is herein incorporated by reference in its entirety.

### BACKGROUND

### 1. Technical Field

The present disclosure relates to the technical field of image recognition, and in particular, to methods and apparatuses for wave recognition, computer-readable storage media, and unmanned aerial vehicles (UAVs).

### 2. Background Information

Currently, a device such as a UAV determines a position thereof according to its relationship with an object in an environment during automatic positioning. For example, if the device remains stationary relative to the object in the environment, it may be determined that the device is stationary. If the device has a displacement relative to the object in the environment, it may be determined that the device is moving.

However, in some scenarios, objects in the environment are moving. For example, when the environment includes a water area, there are waves in the water area, and the waves move all the time and their shapes also change. If the device determines its position according to a relationship with the waves, it is difficult to determine whether the device is moving or not.

Therefore, a manner is required to determine whether there are waves in an environment, so that a device such as a UAV acts according to a result of the determination.

### BRIEF SUMMARY

The present disclosure provides methods and apparatuses for wave recognition, a computer-readable storage media and unmanned aerial vehicles that recognize a wave in an image based on the change of feature information of a target region in the image at different times.

A first aspect of the present disclosure refers to a method for wave recognition, which comprises: extracting a first image acquired by an image acquisition apparatus at a first time and a second image acquired by the image acquisition apparatus at a second time; extracting a target region in each of the first image and the second image; comparing feature information of the target region in the first image with feature information of the target region in the second image; and determining whether the target region is a wave according to a result of the comparison.

A second aspect of the present disclosure refers to an apparatus for wave recognition, which comprises a processor. The processor may be configured to: extract a first image acquired by an image acquisition apparatus at a first time and a second image acquired by the image acquisition apparatus at a second time; extract a target region in each of the first image and the second image; compare feature information of the target region in the first image with feature information of the target region in the second image; and determine whether the target region is a wave according to a result of the comparison.

A third aspect of the present disclosure refers to an unmanned aerial vehicle (UAV), which comprises a processor. The processor may be configured to: extract a first image acquired by an image acquisition apparatus at a first time and a second image acquired by the image acquisition apparatus at a second time; extract a target region in each of the first image and the second image; compare feature information of the target region in the first image with feature information of the target region in the second image; and determine whether the target region is a wave according to a result of the comparison.

It can be seen from the technical solutions provided by the above embodiments of the present disclosure that by comparing the feature information of the target region in the image at different times, the change of the feature information can be determined according to the comparison result. For different objects, when change occurs, the change in the feature information may be different. Therefore, the type of the object that is changing in the actual environment corresponding to the target region can be determined according to the change in the feature information. Therefore, whether the target region in the image is a wave can be determined according to the change in the feature information.

### BRIEF DESCRIPTION OF THE DRAWINGS

In order to describe the technical solutions in the exemplary embodiments of the present disclosure more clearly, the accompanying drawings required to describe the embodiments are briefly described below. Apparently, the accompanying drawings described below are only some exemplary embodiments of the present disclosure. A person of ordinary skill in the art may further obtain other accompanying drawings based on these accompanying drawings without inventive effort.

FIG. 1 is a schematic flowchart of a method for wave recognition according to some exemplary embodiments of the present disclosure;

FIG. 2 is a schematic flowchart of another method for wave recognition according to some exemplary embodiments of the present disclosure;

FIG. 3 is a schematic flowchart of still another method for wave recognition according to some exemplary embodiments of the present disclosure;

FIG. 4 is a schematic flowchart of another method for wave recognition according to some exemplary embodiments of the present disclosure;

FIG. 5 is a schematic flowchart of still another method for wave recognition according to some exemplary embodiments of the present disclosure;

FIG. 6 is a schematic flowchart of determining whether a target region is moving according to some exemplary embodiments of the present disclosure;

FIG. 7 is a schematic flowchart of calculating a second similarity between projection and an edge of a target region in a second image according to some exemplary embodiments of the present disclosure;

FIG. 8 is a schematic flowchart of determining an attitude change of an image acquisition apparatus from a first moment to a second moment according to some exemplary embodiments of the present disclosure;

FIG. 9 is another schematic flowchart of determining an attitude change of an image acquisition apparatus from a first moment to a second moment according to some exemplary embodiments of the present disclosure;

FIG. 10 is a schematic flowchart of extracting a target region in each of a first image and a second image according to some exemplary embodiments of the present disclosure;

FIG. 11 is a schematic flowchart of converting a first image into a first binary image and converting a second image into a second binary image according to some exemplary embodiments of the present disclosure;

FIG. 12 is a schematic flowchart of extracting a target region in a first image by using a first binary image as a mask, and extracting a target region in a second image by using a second binary image as a mask, according to some exemplary embodiments of the present disclosure;

FIG. 13A to FIG. 13D are each a schematic diagram of extracting a target region according to some exemplary embodiments of the present disclosure;

FIG. 14 is a schematic flowchart of another method for wave recognition according to some exemplary embodiments of the present disclosure;

FIG. 15 is a schematic flowchart of still another method for wave recognition according to some exemplary embodiments of the present disclosure;

FIG. 16 is a schematic flowchart of still another method for wave recognition according to some exemplary embodiments of the present disclosure;

FIG. 17 is a schematic flowchart of still another method for wave recognition according to some exemplary embodiments of the present disclosure;

FIG. 18 is a schematic structural diagram of an apparatus for wave recognition according to some exemplary embodiments of the present disclosure; and

FIG. 19 is a schematic structural diagram of an unmanned aerial vehicle according to some exemplary embodiments of the present disclosure.

### DETAILED DESCRIPTION OF THE DRAWINGS

The following clearly describes the technical solutions in the embodiments of the present disclosure with reference to the accompanying drawings in the embodiments of the present disclosure. The described embodiments are merely some but not all of the embodiments of the present disclosure. All other embodiments obtained by persons of ordinary skill in the art based on the embodiments of the present disclosure without creative efforts shall fall within the protection scope of the present disclosure.

It should be noted that, when a component is described as “fixed” to another component, the component may be directly located on another component, or an intermediate component may exist therebetween. When a component is considered as “connected” to another component, the component may be directly connected to another element, or an intermediate element may exist therebetween.

Unless otherwise defined, meanings of all technical and scientific terms used in this specification are the same as those generally understood by persons skilled in the art of the present disclosure. The terms used in this specification of the present disclosure herein are used only to describe specific embodiments, and not intended to limit the present disclosure. The term “and/or” used in this specification includes any or all possible combinations of one or more associated listed items.

The following describes in detail some implementations of the present disclosure with reference to the accompanying drawings. Under a condition that no conflict occurs, the following embodiments and features in the embodiments may be mutually combined. The following description provides specific application scenarios and requirements of the present application in order to enable those skilled in the art to make and use the present application. Various modifications to the disclosed embodiments will be apparent to those skilled in the art. The general principles defined herein may be applied to other embodiments and applications without departing from the spirit and scope of the disclosure. Therefore, the present disclosure is not limited to the embodiments shown, but the broadest scope consistent with the claims.

The terminology used herein is for the purpose of describing particular exemplary embodiments only and is not intended to be limiting. When used in this disclosure, the terms “comprise”, “comprising”, “include” and/or “including” refer to the presence of stated features, integers, steps, operations, elements, and/or components, but do not preclude the presence or addition of one or more other features, integers, steps, operations, elements, components, and/or groups thereof. As used in this disclosure, the term “A on B” means that A is directly adjacent to B (from above or below), and may also mean that A is indirectly adjacent to B (i.e., there is some element between A and B); the term “A in B” means that A is all in B, or it may also mean that A is partially in B.

In view of the following description, these and other features of the present disclosure, as well as operations and functions of related elements of the structure, and the economic efficiency of the combination and manufacture of the components, may be significantly improved. All of these form part of the present disclosure with reference to the drawings. However, it should be clearly understood that the drawings are only for the purpose of illustration and description, and are not intended to limit the scope of the present disclosure. It is also understood that the drawings are not drawn to scale.

In some exemplary embodiments, numbers expressing quantities or properties used to describe or define the embodiments of the present application should be understood as being modified by the terms “about”, “generally”, “approximate,” or “substantially” in some instances. For example, “about”, “generally”, “approximately” or “substantially” may mean a ±20% change in the described value unless otherwise stated. Accordingly, in some exemplary embodiments, the numerical parameters set forth in the written description and the appended claims are approximations, which may vary depending upon the desired properties sought to be obtained in a particular embodiment. In some exemplary embodiments, numerical parameters should be interpreted in accordance with the value of the parameters and by applying ordinary rounding techniques. Although a number of embodiments of the present application provide a broad range of numerical ranges and parameters that are approximations, the values in the specific examples are as accurate as possible.

Each of the patents, patent applications, patent application publications, and other materials, such as articles, books, instructions, publications, documents, products, etc., cited herein are hereby incorporated by reference, which are applicable to all contents used for all purposes, except for any history of prosecution documents associated therewith, or any identical prosecution document history, which may be inconsistent or conflicting with this document, or any such subject matter that may have a restrictive effect on the broadest scope of the claims associated with this document now or later. For example, if there is any inconsistent or conflicting in descriptions, definitions, and/or use of a term associated with this document and descriptions, definitions, and/or use of the term associated with any materials, the term in this document shall prevail.

It should be understood that the embodiments of the application disclosed herein are merely described to illustrate the principles of the embodiments of the application. Other modified embodiments are also within the scope of this application. Therefore, the embodiments disclosed herein are by way of example only and not limitations. Those skilled in the art may adopt alternative configurations to implement the technical solution in this application in accordance with the embodiments of the present application. Therefore, the embodiments of the present application are not limited to those embodiments that have been precisely described in this disclosure.

The following clearly and completely describes the technical solutions in the embodiments of the present disclosure with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure. In addition, if no conflict occurs, the following embodiments and features in the embodiments may be mutually combined.

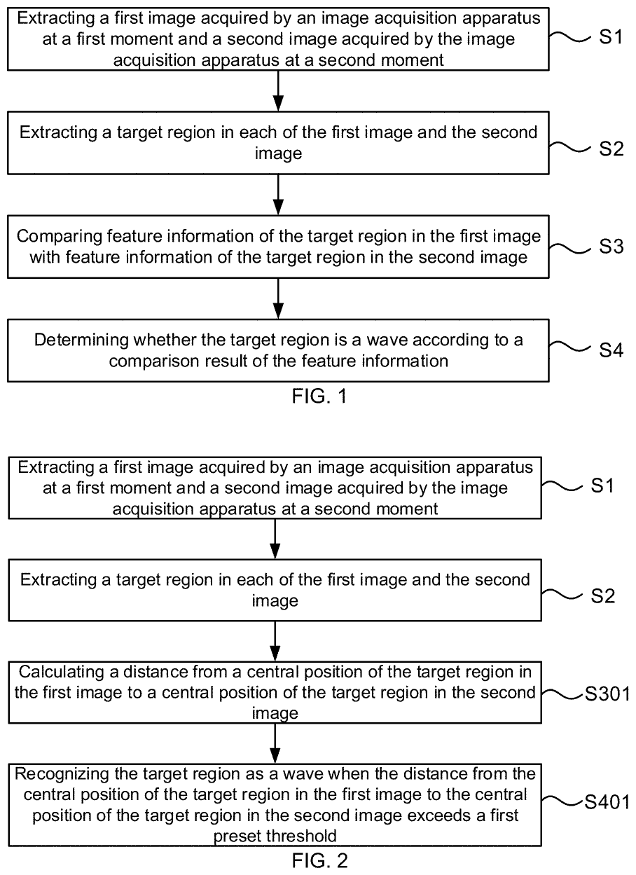

FIG. 1 is a schematic flowchart of a method for wave recognition according to some exemplary embodiments of the present disclosure. The method shown in these embodiments may be applied to a device provided with an image acquisition apparatus, such as an aircraft, a ship, or another delivery vehicle that is provided with an image acquisition apparatus.

As shown in FIG. 1, the method for wave recognition may include the following steps.

Step S1. Extracting a first image acquired by an image acquisition apparatus at a first moment and a second image acquired by the image acquisition apparatus at a second moment.

Step S2. Extracting a target region in each of the first image and the second image.

In some exemplary embodiments, the image acquisition apparatus may acquire images at certain time intervals. An image acquired each time may be referred to as a frame of image. For example, 20 frames of images may be acquired within one second. The first image and the second image may be two adjacent frames of images, or may be two non-adjacent frames of images.

In some exemplary embodiments, the target region may be a region that is determined in an image in a specific manner. The specific manner can ensure to a relatively great extent that the target region in the first image and the target region in the second image correspond to a same object in an actual environment.

The first image may be converted into a first binary image, and the second image may be converted into a second binary image. Then the target region in the first image may be extracted by using the first binary image as a mask, and the target region in the second image may be extracted by using the second binary image as a mask. A specific extraction manner is to be described in detail in subsequent embodiments.

In some exemplary embodiments, a difference between the first moment and the second moment (that is, a time interval) may be less than preset duration. For example, the preset duration may be less than or equal to 0.5 second. This can avoid an inaccurate recognition result caused by a case in which the target region in the first image and the target region in the second image correspond to different objects in the actual environment due to a relatively great change in the actual environment corresponding to the first image and the second image.

Step S3. Comparing feature information of the target region in the first image with feature information of the target region in the second image.

Step S4. Determining whether the target region is a wave according to a comparison result of the feature information.

In some exemplary embodiments, an image may have various types of feature information, such as position information and color information (for example, brightness information or chroma information). A change in the feature information may reflect a change in an object in an actual region corresponding to the image. For example, a change in the position information may reflect a change of the position of the object, and a change in the color information may reflect a change of the color of the object or a shape of the object.

According to these embodiments, feature information of a target region in an image at different moments may be compared, a change in the feature information can be determined according to a comparison result. For different objects, when change occurs, the change in the feature information may be different. Therefore, a type of an object that is changing in an actual environment corresponding to the target region can be determined according to the change in the feature information. In this way, whether the target region in the image is a wave can be further determined according to the change in the feature information.

In some exemplary embodiments, the feature information of the target region may include position information and/or color information.

In some exemplary embodiments, the position information may be determined according to a change in a position of any point in the target region. In some exemplary embodiments, the position information may be determined according to a change in a central position of the target region. For example, the position information is determined according to a distance from a central position of the target region in the first image to a central position of the target region in the second image.

In some exemplary embodiments, the color information may include brightness information, chroma information, or the like. The following mainly describes examples of embodiments of this disclosure by using grayscale information, that is, a grayscale value, in the brightness information as an example. In some exemplary embodiments, a distribution of the grayscale value may be analyzed by using a grayscale histogram in exemplary embodiments of this disclosure. It may be understood that, in some exemplary embodiments, the grayscale histogram may not be used, but a grayscale pie chart, a grayscale value distribution function, or the like may be used to compare grayscale values in the feature information of the target region. This is not limited herein.

FIG. 2 is a schematic flowchart of another method for wave recognition according to some exemplary embodiments of the present disclosure. As shown in FIG. 2, the comparing feature information of the target region in the first image with feature information of the target region in the second image may include the following step(s).

Step S301. Calculating a distance from a central position of the target region in the first image to a central position of the target region in the second image. The determining of whether the target region is a wave according to the comparison result of the feature information may include the following step(s).

Step S401. Recognizing the target region as a wave when the distance from the central position of the target region in the first image to the central position of the target region in the second image exceeds a first preset threshold.

In some exemplary embodiments, after the target region in the first image and the target region in the second image are determined, a central position Wₜ₁ in the target region in the first image and a central position Wₜ₂ in the target region in the first image may be determined. A difference between a second moment t2 and a first moment t1 may be less than the preset duration, for example, less than 0.5 second. Then, a distance from Wₜ₂ to Wₜ₁ may be calculated. The distance may reflect a distance by which an object in an actual environment that corresponds to the target region moves within duration between t1 and t2. Further, a movement speed of the object may be represented based on t1 and t2. Because different objects have different movement speeds, the type of the object that is changing in the actual environment corresponding to the target region may be determined according to a change in the central position of the target region. Because a movement speed of a wave is usually high, the target region may be recognized as a wave when the distance from the central position of the target region in the first image to the central position of the target region in the second image exceeds the first preset threshold.

The first preset threshold may be set as needed, or may be determined according to the difference between the second moment t2 and the first moment t1.

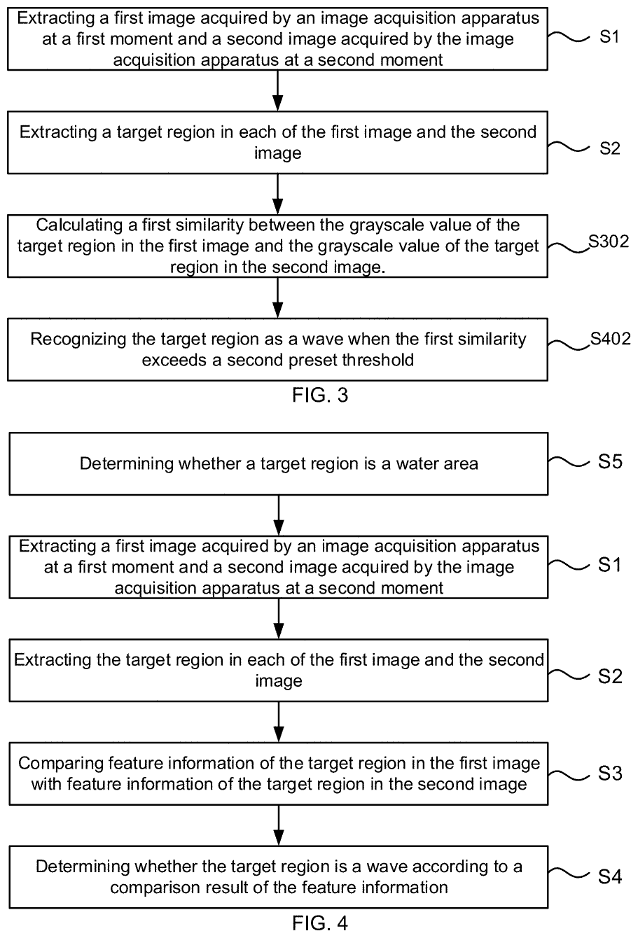

FIG. 3 is a schematic flowchart of still another method for wave recognition according to some exemplary embodiments of the present disclosure. As shown in FIG. 3, the color information may be a grayscale value of the target region. The comparing of the feature information of the target region in the first image with the feature information of the target region in the second image may include the following step(s).

Step S302. Calculating a first similarity between the grayscale value of the target region in the first image and the grayscale value of the target region in the second image. The determining of whether the target region is a wave according to a comparison result of the feature information may include the following step(s).

Step S402. Recognizing the target region as a wave when the first similarity exceeds a second preset threshold.

In some exemplary embodiments, a grayscale image of the target region may be determined. The grayscale image of the target region may be determined after the target region in the first image and the target region in the second image are determined. Alternatively, a grayscale image of each of the first image and the second image may be determined first, and then a target region is determined in each of the two grayscale images. In this way, the grayscale image of the target region may be obtained.

After the grayscale image of the target region is determined, a grayscale value of the target region may be generated according to a grayscale of each pixel in the target region. In some exemplary embodiments, a distribution of the grayscale value may be analyzed by using a grayscale histogram. For example, a grayscale histogram of the target region may be generated according to the grayscale of each pixel in the target region, and then a first similarity between a grayscale histogram Hₜ₁ of the target region in the first image and a grayscale histogram Hₜ₂ of the target region in the second image may be calculated. A change in a grayscale histogram can reflect a change in a shape of an object in an actual environment corresponding to the target region. A wave may change quickly, that is, a degree of change per unit time may be relatively great, and grayscale histogram corresponding to different moments may have a relatively low similarity. Therefore, the target region may be recognized as a wave when the first similarity exceeds the second preset threshold.

FIG. 4 is a schematic flowchart of another method for wave recognition according to some exemplary embodiments of the present disclosure. As shown in FIG. 4, the method may further include the following steps:

Step S5. Determining whether the target region is a water area before the first image acquired by the image acquisition apparatus at the first moment and the second image acquired by the image acquisition apparatus at the second moment are extracted.

If it is determined that the target region is a water area, step S2 may be performed, to extract the first image acquired by the image acquisition apparatus at the first moment and the second image acquired by the image acquisition apparatus at the second moment.

In some exemplary embodiments, whether the target region is a water area may be determined first. For example, whether the device is located near a water area may be determined according to GPS information. For example, it is determined whether a distance from a position of the device to a nearest water area is less than a preset distance. If the distance from the position of the device to the nearest water area is less than the preset distance, it may be determined that the device is located near a water area. Therefore, it may be determined with a high probability that the target region is a water area. After it is determined that the target region is a water area, step S2 may be performed, to extract the first image acquired by the image acquisition apparatus at the first moment and the second image acquired by the image acquisition apparatus at the second moment. This can avoid resource (such as memory or power) consumption and an error in a recognition result caused by performing step S2 to step S4 in the case that the target region is not a water area.

The water area may be a river, a lake, an ocean, or the like.

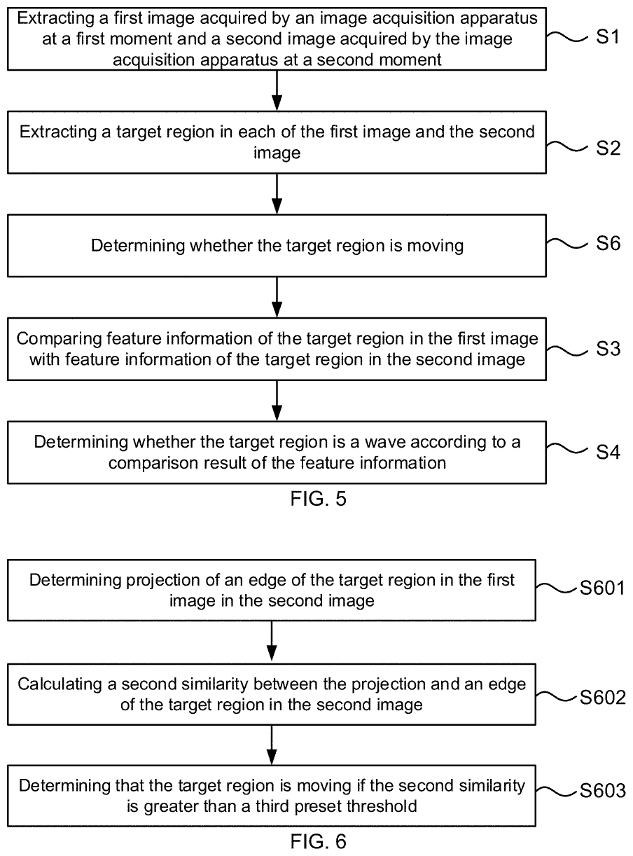

FIG. 5 is a schematic flowchart of still another method for wave recognition according to some exemplary embodiments of the present disclosure. As shown in FIG. 5, the method may further include the following step(s).

Step S6. Determining whether the target region is moving before the feature information of the target region in the first image is compared with feature information of the target region in the second image.

If it is determined that the target region is moving, step S3 may be performed, to compare the feature information of the target region in the first image with the feature information of the target region in the second image.

In some exemplary embodiments, whether the target region is moving may be determined first. A manner of determining whether the target region is moving may include but not limited to calculating a distance from the central position of the target region in the first image to the central position of the target region in the second image. When the distance from the central position of the target region in the first image to the central position of the target region in the second image exceeds the first preset threshold, it is determined that the target region is moving. When this manner is used to determine whether the target region is moving, the feature information for comparison in step S3 may no longer include position information of the target region.

In addition to the foregoing manner of determining whether the target region is moving according to a change in the central position of the target region, whether the target region is moving may be determined based on other manners. These manners are to be described in subsequent embodiments.

Whether the target region is moving may be determined first, and then step S3 may be performed when it is determined that the target region is moving, to compare the feature information of the target region in the first image with the feature information of the target region in the second image. This can avoid resource (such as memory or power) consumption and an error in a recognition result caused by performing step S2 to step S4 in the case that the target region is not moving.

It should be noted that, when the embodiments shown in FIG. 4 and FIG. 5 are combined, the embodiments shown in FIG. 4 may be performed first, and then the embodiments shown in FIG. 5 may be performed. In other words, whether the target region is moving may be determined when it is determined that the target region is a water area, and then the feature information of target region may be compared when it is determined that the target region is moving.

FIG. 6 is a schematic flowchart of determining whether a target region is moving according to some exemplary embodiments of the present disclosure. As shown in FIG. 6, The determining of whether the target region is moving may include the following step(s).

Step S601. Determining projection of an edge of the target region in the first image in the second image.

Step S602. Calculating a second similarity between the projection and an edge of the target region in the second image.

Step S603. Determining that the target region is moving if the second similarity is greater than a third preset threshold.

In some cases, although the target region is not moving, the shape of the target region may change, causing the central position of the target region to change. In these cases, if whether the target region is moving is determined according to the change in the central position of the target region, it may be wrongly determined that the target region is moving.

In some exemplary embodiments, the projection of the edge of the target region in the first image in the second image may be determined, then the second similarity between the projection and the edge of the target region in the second image may be calculated, and it may be determined that the target region is moving when the second similarity is greater than the third preset threshold. Compared with the central position of the target region, the edge of the target region can more comprehensively reflect a specific status of the target region. Therefore, whether the target region is moving can be more accurately determined according to the second similarity between the projection of the edge of the target region in the first image in the second image and the edge of the target region in the second image.

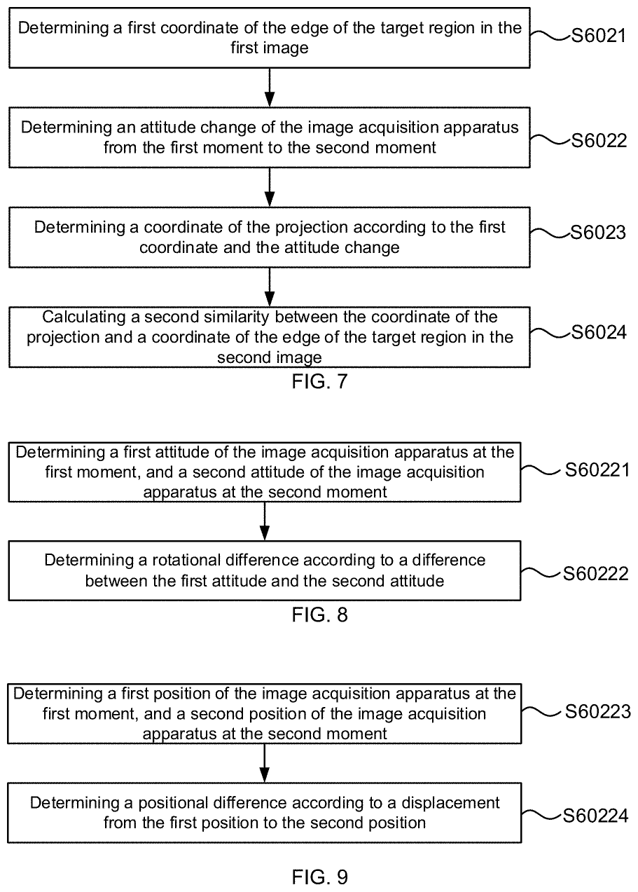

FIG. 7 is a schematic flowchart of calculating a second similarity between a projection and an edge of a target region in a second image according to some exemplary embodiments of the present disclosure. As shown in FIG. 7, the calculating of a second similarity between the projection and an edge of the target region in the second image may include the following step(s).

Step S6021. Determining a first coordinate of the edge of the target region in the first image.

Step S6022. Determining an attitude change of the image acquisition apparatus from the first moment to the second moment.

Step S6023. Determining a coordinate of the projection according to the first coordinate and the attitude change.

Step S6024. Calculating a second similarity between the coordinate of the projection and a coordinate of the edge of the target region in the second image.

In some exemplary embodiments, to calculate the second similarity between the projection and the edge of the target region in the second image, the attitude change of the image acquisition apparatus from the first moment to the second moment may be determined first. In some exemplary embodiments, the attitude change may include a difference between rotations of the image acquisition apparatus at the first moment and the second moment. In some exemplary embodiments, the attitude change may include a difference between positions of the image acquisition apparatus at the first moment and the second moment. It may be understood that, the attitude change may include both a rotational difference and a positional difference of the image acquisition apparatus between the first moment and the second moment. This is not limited to exemplary embodiments.

Further, the determination of the attitude change of the image acquisition apparatus from the first moment to the second moment may include determining a difference between rotations of the image acquisition apparatus at the first moment and the second moment. For example, the first coordinate of the edge of the target region in the first image may be P_{A}. It should be noted that, in exemplary embodiments, the coordinate of an edge refers to a set of coordinates of all or some pixels corresponding to a bezel. Because the attitude of the image acquisition apparatus may be different at different moments, the attitude change of the image acquisition apparatus from the first moment to the second moment may be determined. The attitude change may be represented by a rotational difference (which may be represented by a matrix) R and a positional difference T. In this case, according to the first coordinate P_{A}, the rotational difference R, and the positional difference T, a coordinate P′_{B} of the projection may be determined to be equal to T plus a product of P_{A} and R.

Accordingly, the first coordinate may be projected to the second image, to be compared with the coordinate P_{B} of the edge of the target region in the second image. For example, same pixels in P_{A} and P_{B} may be determined. A mapped pixel in P′_{B} that corresponds to each same pixel in P_{A} is then determined, and then the mapped pixel is compared with the same pixel in P_{B}. The second similarity can be determined according to a comparison result of multiple pixels. Distances between pixels may be compared, or information such as chroma, grayscale, and contrast of pixels may be compared.

FIG. 8 is a schematic flowchart of determining an attitude change of an image acquisition apparatus from a first moment to a second moment according to some exemplary embodiments of the present disclosure. As shown in FIG. 8, the determining an attitude change of the image acquisition apparatus from the first moment to the second moment may include the following step(s).

Step S60221. Determining a first attitude of the image acquisition apparatus at the first moment, and a second attitude of the image acquisition apparatus at the second moment.

Step S60222. Determining a rotational difference according to a difference between the first attitude and the second attitude.

In some exemplary embodiments, the attitude change of the image acquisition apparatus may be represented in two aspects, one of which may be the rotational difference, that is, a difference between the first attitude at the first moment and the second attitude at the second moment. The first attitude may include a first orientation, a first pitch angle, and a first roll angle of the image acquisition apparatus at the first moment. The second attitude may include a second orientation, a second pitch angle, and a second roll angle of the image acquisition apparatus at the second moment. The rotational difference may be determined according to a first angular difference between the first orientation and the second orientation, a second angular difference between the first pitch angle and the second pitch angle, and a third angular difference between the first roll angle and the second roll angle.

The attitude change may be determined by using an inertial measurement unit (IMU).

FIG. 9 is another schematic flowchart of determining an attitude change of an image acquisition apparatus from a first moment to a second moment according to some exemplary embodiments of the present disclosure. As shown in FIG. 9, the determination of the attitude change of the image acquisition apparatus from the first moment to the second moment may include the following step(s).

Step S60223. Determining a first position of the image acquisition apparatus at the first moment, and a second position of the image acquisition apparatus at the second moment.

Step S60224. Determining a positional difference according to a displacement from the first position to the second position.

In some exemplary embodiments, the other aspect that represents the attitude change of the image acquisition apparatus may be the positional difference, that is, a difference between the first position of the image acquisition apparatus at the first moment and the second position of the image acquisition apparatus at the second moment. The first position of the image acquisition apparatus at the first moment and the second position of the image acquisition apparatus at the second moment may be obtained through GPS.

It should be noted that, the attitude change of the image acquisition apparatus may include both the rotational difference and the positional difference. The rotational difference may be represented by a matrix R. The positional difference may be represented by a distance T. In this case, the coordinate P′_{B} of the projection is equal to T plus a product of P_{A} and R.

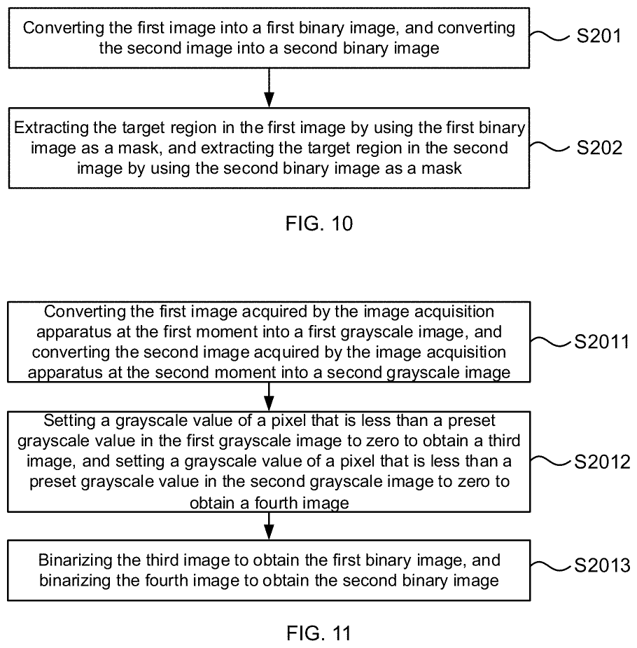

FIG. 10 is a schematic flowchart of extracting a target region in each of a first image and a second image according to some exemplary embodiments of the present disclosure. As shown in FIG. 10, the extracting a target region in each of the first image and the second image may include the following step(s).

Step S201. Converting the first image into a first binary image, and converting the second image into a second binary image.

Step S202. Extracting the target region in the first image by using the first binary image as a mask, and extracting the target region in the second image by using the second binary image as a mask.

In some exemplary embodiments, to extract the target region in the first image and the target region in the second image, first, the first image may be converted into a first binary image, and the second image may be converted into a second binary image. A wave may usually be found in water, and a color (which may usually be white) of the wave may be lighter than a color (which may be blue or green) of a non-wave. Therefore, in a binary image, brightness of a point corresponding to the wave may be higher. That is, a point whose value is the largest in the binary image may be a point in a region in the image that corresponds to the wave. Using a mask for extraction can extract a region in each of the first image and the second image that corresponds to the point whose value is the largest in the binary image, that is, extract a region that may be a wave as the target region. Then, only the target region may be analyzed, and it is not necessarily to analyze the entire image, so that recognition workload can be effectively reduced, and interference caused by a non-wave image can be reduced to some extent, thereby improving recognition accuracy.

FIG. 11 is a schematic flowchart of converting a first image into a first binary image and converting a second image into a second binary image according to some exemplary embodiments of the present disclosure. As shown in FIG. 11, the converting of the first image into a first binary image, and the converting of the second image into a second binary image may include the following step(s).

Step S2011. Converting the first image acquired by the image acquisition apparatus at the first moment into a first grayscale image, and converting the second image acquired by the image acquisition apparatus at the second moment into a second grayscale image.

Step S2012. Setting a grayscale value of a pixel that is less than a preset grayscale value in the first grayscale image to zero to obtain a third image, and setting a grayscale value of a pixel that is less than a preset grayscale value in the second grayscale image to zero to obtain a fourth image.

Step S2013. Binarizing the third image to obtain the first binary image, and binarizing the fourth image to obtain the second binary image.

In some exemplary embodiments, to convert an image into a binary image, first, the image may be converted into a grayscale image. Pixels in the image that represent a wave may usually have relatively high grayscales, after being binarized, the pixels may have values that are the largest values in the image. However, there may also be some pixels in the image that do not represent a wave, such as scattered ripples or bubbles. Although grayscales of these pixels are not high, after these pixels are binarized, values of these pixels may still be the largest in the image. To avoid recognition of these pixels with low grayscales, a grayscale of a pixel whose grayscale value is less than a preset grayscale value in the grayscale image may be set to zero, so that all of the pixels whose values are the largest in the binary image are probably the points representing a wave, and then recognition may be performed. This can effectively reduce recognition workload, and reduce to some extent interference caused by a non-wave point, thereby improving recognition accuracy.

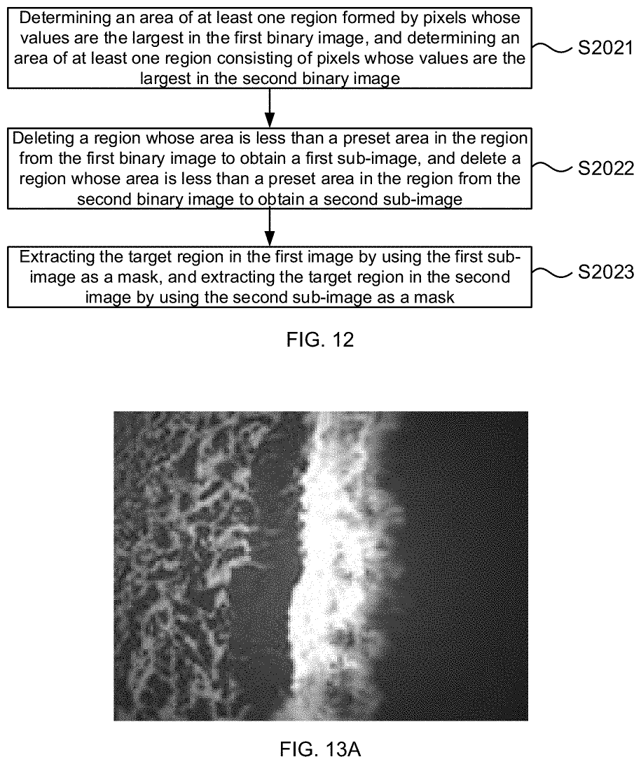

FIG. 12 is a schematic flowchart of extracting a target region in a first image by using a first binary image as a mask, and extracting a target region in a second image by using a second binary image as a mask. As shown in FIG. 12, the extracting of the target region in the first image by using the first binary image as a mask, and the extracting of the target region in the second image by using the second binary image as a mask may include the following step(s).

Step S2021. Determining an area of at least one region formed by pixels whose values are the largest in the first binary image, and determining an area of at least one region formed by pixels whose values are the largest in the second binary image.

Step S2022. Deleting a region whose area is less than a preset area in the region from the first binary image to obtain a first sub-image, and deleting a region whose area is less than a preset area in the region from the second binary image to obtain a second sub-image.

Step S2023. Extracting the target region in the first image by using the first sub-image as a mask, and extracting the target region in the second image by using the second sub-image as a mask.

In some exemplary embodiments, a wave may usually have a relatively large area, but there may be some objects that are not waves but still have relatively high grayscales in a water area in which the wave is located, such as scattered ripples or domestic garbage. These objects may have smaller areas than regions of waves whose grayscales are usually higher. Therefore, areas of regions formed by pixels whose values are the largest may be determined in the binary image, and then the areas may be compared with a preset area. An area that is less than the preset area may be deleted to obtain a sub-image, so that all of the pixels in the sub-image are probably points representing a wave, and then recognition may be performed. This can effectively reduce recognition workload, and reduce to some extent interference caused by a non-wave point, thereby improving recognition accuracy.

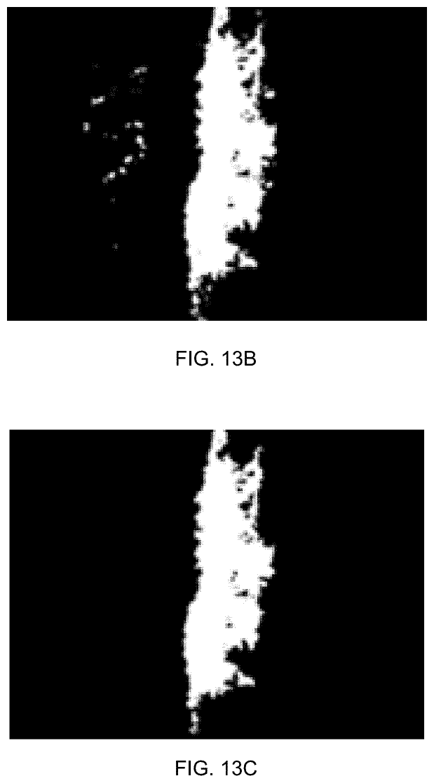

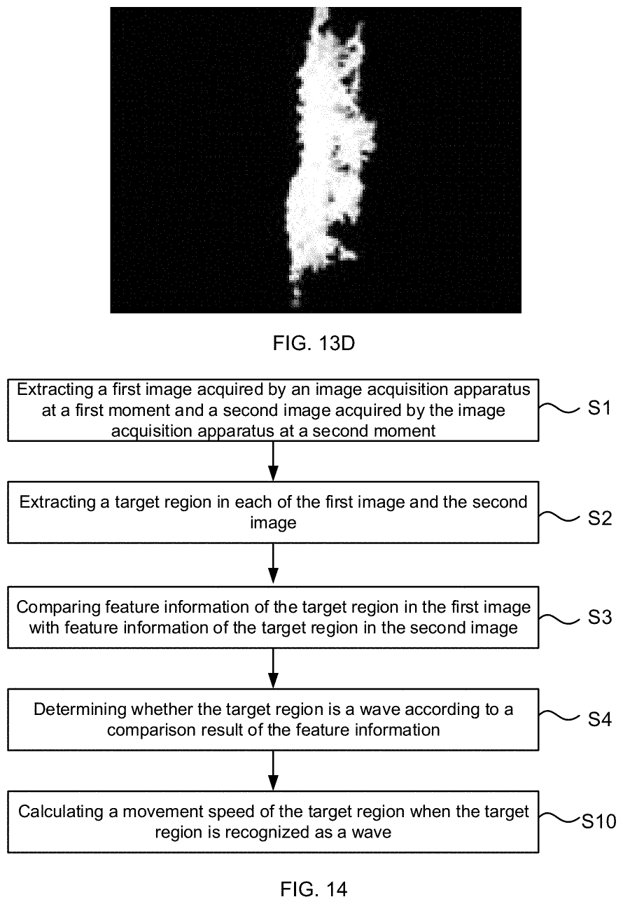

FIG. 13A to FIG. 13D are each a schematic diagram of extracting a target region according to some exemplary embodiments of this disclosure. This manner may be applied to extracting a target region in a first image and extracting a target region in a second image. For ease of description, for example, an image shown in FIG. 13A may be a first image.

FIG. 13A shows a first image acquired by an image acquisition apparatus. The first image may be a color image, or may be a grayscale image. If the first image is a grayscale image, step S2011 in the embodiments shown in FIG. 11 does not need to be performed, but the first image may be directly converted into a binary image. If the first image is a color image, step S2011 in the embodiments shown in FIG. 11 may be performed first, to convert the first image into a grayscale image, and then the grayscale image may be converted into a binary image shown in FIG. 13B.

It can be learned through comparison between FIG. 13A and FIG. 13B that, in addition to forming a region with a relatively large area, pixels whose values are the largest in FIG. 13B also form multiple scattered regions with relatively small areas. These regions with relatively small areas may actually be some scattered ripples and bubbles after the dissipation of waves in FIG. 13A. To delete these regions with relatively small areas, processing may be performed according to the embodiments shown in FIG. 12. A region whose area is less than a preset area in the region may be deleted from the first binary image to obtain a first sub-image. The first sub-image is shown in FIG. 13C, and only a region corresponding to a wave in FIG. 13A remains.

Further, the first sub-image shown in FIG. 13C may be used as a mask to extract the target region in the first image. A region formed by pixels whose values are the largest in the first sub-image may be a region corresponding to a wave with a high probability. Therefore, using the first sub-image as a mask can accurately extract a target region that may be a wave from the first image. The extracted target region is shown in FIG. 13D. It can be learned from the corresponding first image shown in FIG. 13A that, the extracted target region may be the region corresponding to the wave in FIG. 13A. A manner of performing extraction by using a mask may be, for example, flood fill. It may be understood that, these embodiments are merely exemplary descriptions. The target region may be extracted by using any suitable extraction method. This is not limited to exemplary embodiments.

In some exemplary embodiments, a difference between the first moment and the second moment is less than preset duration.

In some exemplary embodiments, if the difference between the first moment and the second moment is relatively large, an actual environment corresponding to the first image and the second image may have changed greatly. This may cause the target region in the first image and the target region in the second image to correspond to different objects in the actual environment, making a recognition result inaccurate. Therefore, to avoid a relatively great change in the actual environments corresponding to the first image and the second image, the difference between the first moment corresponding to the acquiring of the first image and the second moment corresponding to the acquiring of the second image may be relatively small, for example, less than preset duration, so that it can be ensured with a high probability that the target region in the first image and the target region in the second image correspond to a same object in the actual environment, thereby ensuring the accuracy of a recognition result.

In some exemplary embodiments, the preset duration is 0.5 second. Appropriately setting the preset duration can avoid a relatively large change in the actual environment corresponding to the first image and the second image, and can avoid an extremely small difference between the first moment and the second moment. The extremely small difference may cause the object corresponding to the target region in the actual environment to remain basically unchanged, that is, cause the feature information of the first image and the feature information of the second image to basically have no difference, resulting in inaccurate recognition of a wave.

FIG. 14 is a schematic flowchart of another method for wave recognition according to some exemplary embodiments of the present disclosure. As shown in FIG. 14, the method for wave recognition may further include the following step(s).

Step S10: Calculating a movement speed of the target region when the target region is recognized as a wave.

In some exemplary embodiments, when the target region is recognized as a wave, the movement speed of the target region may be further calculated, so that an operation may be subsequently performed according to the movement speed of the wave, for example, controlling the device to move.

In some exemplary embodiments, the calculating of the movement speed of the target region may include: calculating the movement speed of the target region by using an optical flow method.

In some exemplary embodiments, the movement speed of the target region may be calculated by using the optical flow method.

First, a Harris corner is extracted for the target region, and then sufficiently small duration is set for a pixel P whose position at a moment tin an image is (x, y). In this case, there exists the following formula: I(x+μδt, y+υδt, t+δt)=I(x, y, t).

Taylor expansion is performed on the formula to obtain the following formula:

$$I ( x , y , t ) + \frac{\partial I}{\partial x} δ x + \frac{\partial I}{\partial y} δ y + \frac{\partial I}{\partial t} δ t = I ( x , y , t ) ;$$

that is,

$$\frac{\partial I}{\partial x} δ x + \frac{\partial I}{\partial y} δ y + \frac{\partial I}{\partial t} δ t = 0 , ,$$

which is expressed as Iₓμ+I_{y}υ+Iₜ=0 for short, where

$${I}_{x} = \frac{\partial I}{\partial x} , {I}_{y} = \frac{\partial I}{\partial y} , {I}_{t} = \frac{\partial }{\partial t} , μ = \frac{dx}{dt} , and v = \frac{dy}{dt} ;$$

and the Horn-Shunck (an optical flow method) may be applied to solve values of μ and υ, and an average value of the Harris corner point (μ, υ) is the movement speed of the target region.

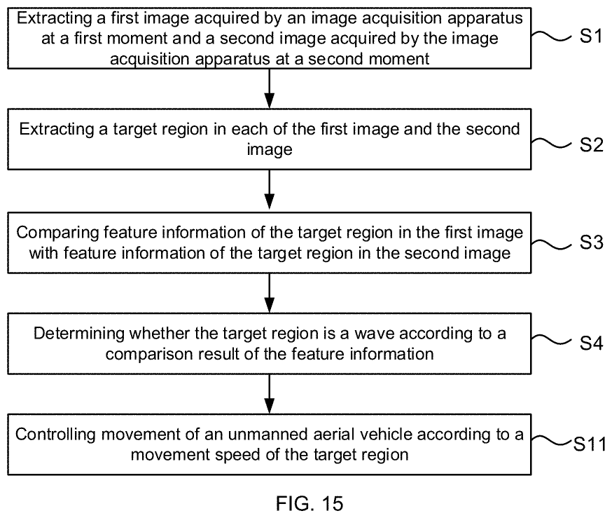

FIG. 15 is a schematic flowchart of still another method for wave recognition according to some exemplary embodiments of the present disclosure. As shown in FIG. 15, the method may be applied to a UAV. The method may further include the following step(s).

Step S11. Controlling movement of the UAV according to the movement speed of the target region.

In some exemplary embodiments, when the method is applicable to a UAV, the movement of the UAV may be controlled according to the movement speed of the target region. Because the target region is recognized as a wave, the controlling of the movement of the UAV according to the speed of the wave can implement an operation such as following the wave. When a target object tracked by the UAV is a wave, the UAV is less likely to lose the target object, thereby improving the reliability and stability of automatic tracking. For example, when the UAV tracks a surfer, the UAV may easily lose the target object because the surfer is very small compared with the wave.

It should be noted that, in addition to controlling the UAV to follow the target region according to the movement speed of the target region, the controlling of the movement of the UAV according to the movement speed of the target region may further include: controlling, according to the movement speed of the target region, the UAV to approach the target region, or to move away from the target region. How the UAV is specifically controlled to move may be set as needed.

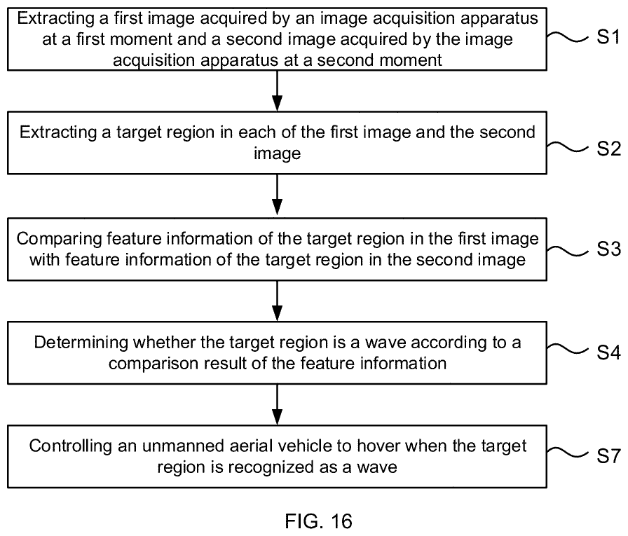

FIG. 16 is a schematic flowchart of still another method for wave recognition according to some exemplary embodiments of the present disclosure. As shown in FIG. 16, the method may be applied to a UAV. The method may further include the following step(s).

Step S7. Controlling the UAV to hover when the target region is recognized as a wave.

The UAV can hover automatically according to an environment, and can determine, according to a change of an object in the environment, whether the UAV is moving. For example, if an object in the environment is changing, the UAV may determine that the UAV is moving. To hover automatically, the UAV may control the movement of the UAV to maintain the object in the environment unchanged as much as possible, that is, hovers by remaining relatively stationary with the object in the environment. However, such a manner may be based on a case in which the object in the environment is almost stationary. When there are waves in the environment, because the waves are constantly moving with constantly changing shapes, to maintain relatively stationary with the object in the environment, the UAV may control the movement of the UAV. In this case, the UAV may move in a direction of the movement of the waves, resulting in a problem of drifting with the waves.

In some exemplary embodiments, the UAV may be controlled to hover when the target region is recognized as a wave. For example, the UAV may be controlled to hover according to position information (the position information may be received from a controller, or may be determined by the UAV according to a GPS module of the UAV). For example, the UAV may be controlled to hover at a current position, or the UAV may be controlled to hover at a specified position, instead of being automatically controlled to hover according to a movement status of an object in the environment, thereby avoiding movement of the UAV with the wave.

In some exemplary embodiments, the controlling the UAV to hover may include: controlling the UAV to hover at the current position. That is, the UAV may be controlled to hover at the current position without further movement.

In some exemplary embodiments, the method may be applied to a UAV. The method may further include: when the target region is recognized as a wave, generating prompt information if the UAV is currently positioned according to an object in an environment, where the prompt information is used to prompt adjustment of a positioning strategy.

In some exemplary embodiments, as described above, when the target region is a wave, if the UAV is positioned according to an object in the environment, the UAV may be caused to move with the wave. However, when prompt information is generated to prompt adjustment of a positioning strategy, where the prompt information may be sent to a controller of the UAV, or may be received by a processor of the UAV, the controller or the processor of the UAV can adjust the positioning strategy, so that the UAV is positioned according to, for example, the position information, instead of being positioned according to an object in the environment, thereby avoiding movement of the UAV with the wave.

In some exemplary embodiments, the adjustment of the positioning strategy may include: prompting the UAV to increase a priority of determining a position according to GPS positioning information. That is, the UAV may preferentially determine a position according to the GPS positioning information, thereby avoiding performing positioning preferentially according to an object in the environment.

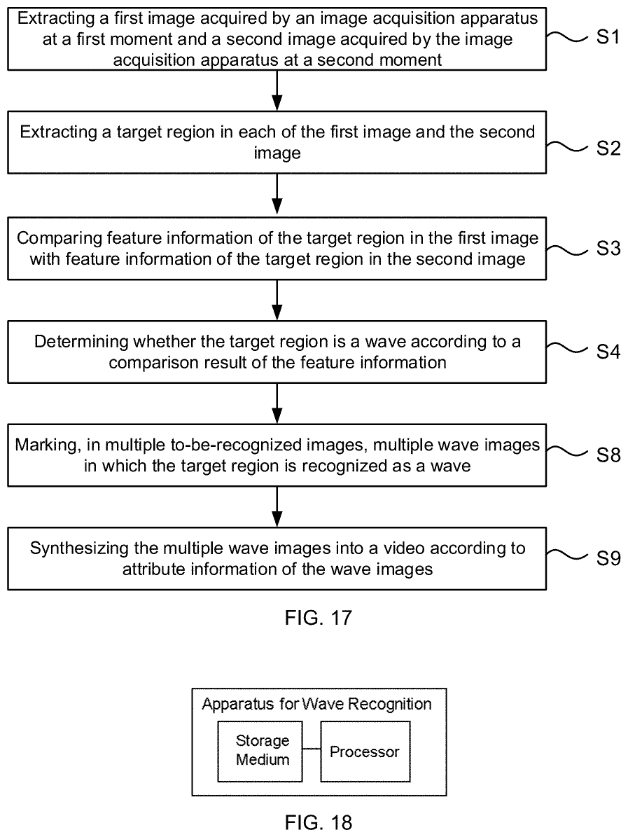

FIG. 17 is a schematic flowchart of still another method for wave recognition according to some exemplary embodiments of the present disclosure. As shown in FIG. 17, the method may further include the following step(s).

Step S8. Marking, in multiple to-be-recognized images, multiple wave images in which the target region is recognized as a wave.

Step S9. Synthesizing the multiple wave images into a video according to attribute information of the wave images.

In some exemplary embodiments, multiple wave images in which the target region is recognized as a wave may be marked in multiple to-be-recognized images, and then the multiple wave images can be synthesized into a video according to the attribute information of the wave images. The attribute information may include at least one of the following: time and location.

For example, if the attribute information includes time, wave images corresponding to earlier times may be synthesized into earlier image frames in the video, and wave images corresponding to later times may be synthesized into later image frames in the video. For example, if the attribute information includes location, wave images corresponding to some locations may be synthesized into earlier image frames in the video as needed, and wave images corresponding to some other locations may be synthesized into later image frames in the video.

In some exemplary embodiments, an image sampling including a wave may be acquired in advance. Then, machine learning may be performed according to the image sample, to obtain a model used to recognize the wave in the image sample. Further, the target region may be verified according to the model when the target region is recognized as a wave according to the foregoing embodiment. It is determined that the target region is indeed a wave only when the target region is verified to be a wave, thereby improving the accuracy of determining whether a target region is a wave.

Embodiments of the present disclosure further provide a computer-readable storage medium, where the computer-readable storage medium stores several computer instructions, and when the computer instructions are executed, for example, by a processor, the following processing may be performed: extracting a first image acquired by an image acquisition apparatus at a first moment and a second image acquired by the image acquisition apparatus at a second moment; extracting a target region in each of the first image and the second image; comparing feature information of the target region in the first image with feature information of the target region in the second image; and determining whether the target region is a wave according to a comparison result of the feature information.

In some exemplary embodiments, the feature information of the target region may include position information and/or color information.

In some exemplary embodiments, when the computer instructions are executed, the following processing may be performed: calculating a distance from the central position of the target region in the first image to the central position of the target region in the second image; and The determining of whether the target region is a wave according to a comparison result of the feature information may include: recognizing the target region as a wave when the distance from the central position of the target region in the first image to the central position of the target region in the second image exceeds a first preset threshold.

In some exemplary embodiments, when the computer instructions are executed, the following processing may be performed: calculating a first similarity between the grayscale value of the target region in the first image and the grayscale value of the target region in the second image; and recognizing the target region as a wave when the first similarity exceeds a second preset threshold.

In some exemplary embodiments, a distribution of the grayscale value of the target region may be analyzed by using a grayscale histogram.

In some exemplary embodiments, when the computer instructions are executed, the following processing may be performed: determining whether the target region is a water area before the first image acquired by the image acquisition apparatus at the first moment and the second image acquired by the image acquisition apparatus at the second moment are extracted, where the first image acquired by the image acquisition apparatus at the first moment and the second image acquired by the image acquisition apparatus at the second moment may be extracted if it is determined that the target region is a water area.

In some exemplary embodiments, when the computer instructions are executed, the following processing may be performed: determining whether the target region is moving before the feature information of the target region in the first image is compared with feature information of the target region in the second image, where the feature information of the target region in the first image may be compared with feature information of the target region in the second image if it is determined that the target region is moving.

In some exemplary embodiments, when the computer instructions are executed, the following processing may be performed: determining projection of an edge of the target region in the first image in the second image; calculating a second similarity between the projection and an edge of the target region in the second image; and determining that the target region is moving if the second similarity is greater than a third preset threshold.

In some exemplary embodiments, when the computer instructions are executed, the following processing may be performed: determining a first coordinate of the edge of the target region in the first image; determining an attitude change of the image acquisition apparatus at the first moment and the second moment; determining a coordinate of the projection according to the first coordinate and the attitude change; and calculating a second similarity between the coordinate of the projection and a coordinate of the edge of the target region in the second image.

In some exemplary embodiments, when the computer instructions are executed, the following processing may be performed: determining a first attitude of the image acquisition apparatus at the first moment, and a second attitude of the image acquisition apparatus at the second moment; and determining a rotational difference according to a difference between the first attitude and the second attitude.

In some exemplary embodiments, when the computer instructions are executed, the following processing may be performed: determining a first position of the image acquisition apparatus at the first moment, and a second position of the image acquisition apparatus at the second moment; and determining a positional difference according to a displacement from the first position to the second position.

In some exemplary embodiments, when the computer instructions are executed, the following processing may be performed: converting the first image into a first binary image, and converting the second image into a second binary image.

In some exemplary embodiments, when the computer instructions are executed, the following processing may be performed: converting the first image acquired by the image acquisition apparatus at the first moment into a first grayscale image, and converting the second image acquired by the image acquisition apparatus at the second moment into a second grayscale image; setting a grayscale value of a pixel that is less than a preset grayscale value in the first grayscale image to zero to obtain the third image, and setting a grayscale value of a pixel that is less than a preset grayscale value in the second grayscale image to zero to obtain the fourth image; and binarizing the third image to obtain the first binary image, and binarizing the fourth image to obtain the second binary image.

In some exemplary embodiments, when the computer instructions are executed, the following processing is further performed: extracting the target region in the first image by using the first binary image as a mask, and extracting the target region in the second image by using the second binary image as a mask.

In some exemplary embodiments, when the computer instructions are executed, the following processing may be performed: determining an area of at least one region formed by pixels whose values are the largest in the first binary image, and determining an area of at least one region formed by pixels whose values are the largest in the second binary image; deleting a region whose area is less than a preset area in the region from the first binary image to obtain a first sub-image, and deleting a region whose area is less than a preset area in the region from the second binary image to obtain a second sub-image; and extracting the target region in the first image by using the first sub-image as a mask, and extracting the target region in the second image by using the second sub-image as a mask.

In some exemplary embodiments, a difference between the first moment and the second moment may be less than preset duration.

In some exemplary embodiments, the preset duration may be 0.5 second.

In some exemplary embodiments, when the computer instructions are executed, the following processing may be performed: calculating a movement speed of the target region when the target region is recognized as a wave.

In some exemplary embodiments, when the computer instructions are executed, the following processing may be performed: calculating the movement speed of the target region by using an optical flow method.

In some exemplary embodiments, the computer-readable storage medium is applicable to a UAV, where when the computer instructions are executed, the following processing may be performed: controlling the movement of the UAV according to the movement speed of the target region.

In some exemplary embodiments, when the computer instructions are executed, the following processing may be performed: controlling, according to the movement speed of the target region, the UAV to follow the target region, or to approach the target region, or to move away from the target region.

In some exemplary embodiments, the computer-readable storage medium is applicable to a UAV, where when the computer instructions are executed, the following processing may be performed: controlling the UAV to hover when the target region is recognized as a wave.

In some exemplary embodiments, when the computer instructions are executed, the following processing may be performed: controlling the UAV to hover at a current position.

In some exemplary embodiments, the computer-readable storage medium is applicable to a UAV, where when the computer instructions are executed, the following processing may be performed: when the target region is recognized as a wave, generating prompt information if the UAV is currently positioned according to an object in an environment, where the prompt information may be used to prompt adjustment of a positioning strategy.

In some exemplary embodiments, the adjusting of the positioning strategy may include: prompting the UAV to increase a priority of determining a position according to GPS positioning information.

In some exemplary embodiments, when the computer instructions are executed, the following processing may be performed: marking, in multiple to-be-recognized images, multiple wave images in which the target region is recognized as a wave; and synthesizing the multiple wave images into a video according to attribute information of the wave images.

In some exemplary embodiments, the attribute information may include at least one of the following: time and location.

FIG. 18 is a schematic structural diagram of an apparatus for wave recognition according to some exemplary embodiments of the present disclosure.

The apparatus for wave recognition may include a processor and a storage medium. The processor may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor may also be one or more special-purpose processing devices such as an application-specific integrated circuit (ASIC), a field programmable gate array (FPGA), a digital signal processor (DSP), network processor, or the like. The processor may represent one or more general-purpose processing devices such as a microprocessor, central processing unit, or the like. The processor may be configured to execute instructions stored in the storage medium for performing the operations and/or steps discussed herein. The storage medium may include read-only memory (ROM), flash memory, dynamic random access memory (DRAM), synchronous DRAM (SDRAM)), static memory, flash memory, sialic random access memory (SRAM), hard disk, and/or other type of non-transitory storage device, which communicates with each other via a bus.

The processor may be configured to: extract a first image acquired by an image acquisition apparatus at a first moment and a second image acquired by the image acquisition apparatus at a second moment; extract a target region in each of the first image and the second image; compare feature information of the target region in the first image with feature information of the target region in the second image; and determine whether the target region is a wave according to a comparison result of the feature information.

In some exemplary embodiments, the feature information of the target region may include position information and/or color information.

In some exemplary embodiments, the processor may be configured to: calculate a distance from the central position of the target region in the first image to the central position of the target region in the second image; and The determining of whether the target region is a wave according to a comparison result of the feature information may include: recognizing the target region as a wave when the distance from the central position of the target region in the first image to the central position of the target region in the second image exceeds a first preset threshold.

In some exemplary embodiments, the processor may be configured to: calculate a first similarity between the grayscale value of the target region in the first image and the grayscale value of the target region in the second image; and

recognize the target region as a wave when the first similarity exceeds a second preset threshold.

In some exemplary embodiments, the processor may be configured to analyze a distribution of the grayscale value of the target region by using a grayscale histogram.

In some exemplary embodiments, the processor may further be configured to: determine whether the target region is a water area before the first image acquired by the image acquisition apparatus at the first moment and the second image acquired by the image acquisition apparatus at the second moment are extracted, where the first image acquired by the image acquisition apparatus at the first moment and the second image acquired by the image acquisition apparatus at the second moment are extracted if it is determined that the target region is a water area.

In some exemplary embodiments, the processor may further be configured to: determine whether the target region is moving before the feature information of the target region in the first image is compared with feature information of the target region in the second image, where the feature information of the target region in the first image is compared with feature information of the target region in the second image if it is determined that the target region is moving.

In some exemplary embodiments, the processor may be configured to: determine projection of an edge of the target region in the first image in the second image; calculate a second similarity between the projection and an edge of the target region in the second image; and determine that the target region is moving if the second similarity is greater than a third preset threshold.

In some exemplary embodiments, the processor may be configured to: determine a first coordinate of the edge of the target region in the first image; determine an attitude change of the image acquisition apparatus at the first moment and the second moment; determine a coordinate of the projection according to the first coordinate and the attitude change; and calculate a second similarity between the coordinate of the projection and a coordinate of the edge of the target region in the second image.

In some exemplary embodiments, the processor may be configured to: determine a first attitude of the image acquisition apparatus at the first moment, and a second attitude of the image acquisition apparatus at the second moment; and determine a rotational difference according to a difference between the first attitude and the second attitude.

In some exemplary embodiments, the processor may be configured to: determine a first position of the image acquisition apparatus at the first moment, and a second position of the image acquisition apparatus at the second moment; and determine a positional difference according to a displacement from the first position to the second position.

In some exemplary embodiments, the processor may be configured to: convert the first image into a first binary image, and convert the second image into a second binary image.

In some exemplary embodiments, the processor may be configured to: convert the first image acquired by the image acquisition apparatus at the first moment into a first grayscale image, and convert the second image acquired by the image acquisition apparatus at the second moment into a second grayscale image; set a grayscale value of a pixel that is less than a preset grayscale value in the first grayscale image to zero to obtain a third image, and set a grayscale value of a pixel that is less than a preset grayscale value in the second grayscale image to zero to obtain a fourth image; and binarize the third image to obtain the first binary image, and binarize the fourth image to obtain the second binary image.

The processor may further be configured to: extract the target region in the first image by using the first binary image as a mask, and extract the target region in the second image by using the second binary image as a mask.

In some exemplary embodiments, the processor may be configured to: determine an area of at least one region formed by pixels whose values are the largest in the first binary image, and determine an area of at least one region formed by pixels whose values are the largest in the second binary image; delete a region whose area is less than a preset area in the region from the first binary image to obtain a first sub-image, and delete a region whose area is less than a preset area in the region from the second binary image to obtain a second sub-image; and extract the target region in the first image by using the first sub-image as a mask, and extract the target region in the second image by using the second sub-image as a mask.

In some exemplary embodiments, a difference between the first moment and the second moment may be less than preset duration.

In some exemplary embodiments, the preset duration may be 0.5 second.

In some exemplary embodiments, the processor may further be configured to calculate a movement speed of the target region when the target region is recognized as a wave.

In some exemplary embodiments, the processor may be configured to: calculate the movement speed of the target region by using an optical flow method.

In some exemplary embodiments, the apparatus is applicable to a UAV, where the processor may further be configured to: control movement of the UAV according to the movement speed of the target region.

In some exemplary embodiments, the processor may be configured to: control, according to the movement speed of the target region, the UAV to follow the target region, or to approach the target region, or to move away from the target region.

In some exemplary embodiments, the apparatus is applicable to a UAV, where the processor may further be configured to: control the UAV to hover when the target region is recognized as a wave.

In some exemplary embodiments, the processor may further be configured to: control the UAV to hover at a current position.

In some exemplary embodiments, the apparatus is applicable to a UAV, where the processor may further be configured to: when the target region is recognized as a wave, generate prompt information if the UAV is currently positioned according to an object in an environment, where the prompt information is used to prompt adjustment of a positioning strategy.

In some exemplary embodiments, the adjustment of the positioning strategy may include: prompting the UAV to increase a priority of determining a position according to GPS positioning information.

In some exemplary embodiments, the processor may further be configured to: mark, in multiple to-be-recognized images, multiple wave images in which the target region is recognized as a wave; and synthesize the multiple wave images into a video according to attribute information of the wave images.

In some exemplary embodiments, the attribute information may include at least one of the following: time and location.

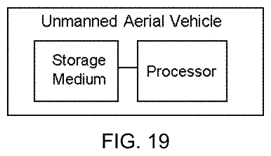

FIG. 19 is a schematic structural diagram of an unmanned aerial vehicle (UAV) according to some exemplary embodiments of the present disclosure.

The apparatus for wave recognition may include a processor and a storage medium. The processor may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor may also be one or more special-purpose processing devices such as an application-specific integrated circuit (ASIC), a field programmable gate array (FPGA), a digital signal processor (DSP), network processor, or the like. The processor may represent one or more general-purpose processing devices such as a microprocessor, central processing unit, or the like. The processor may be configured to execute instructions stored in the storage medium for performing the operations and/or steps discussed herein. The storage medium may include read-only memory (ROM), flash memory, dynamic random access memory (DRAM), synchronous DRAM (SDRAM)), static memory, flash memory, sialic random access memory (SRAM), hard disk, and/or other type of non-transitory storage device, which communicates with each other via a bus.

The UAV may include a processor. It should be noted that, the UAV may include the wave recognition apparatus in the foregoing embodiment. In this case, the processor in the UAV may be the processor in the wave recognition apparatus, or may be a processor outside the wave recognition apparatus. In some exemplary embodiments, the UAV may not include the wave recognition apparatus in the foregoing embodiment. The processor may be configured to: extract a first image acquired by an image acquisition apparatus at a first moment and a second image acquired by the image acquisition apparatus at a second moment; extract a target region in each of the first image and the second image; compare feature information of the target region in the first image with feature information of the target region in the second image; and determine whether the target region is a wave according to a comparison result of the feature information.

In some exemplary embodiments, the feature information of the target region may include position information and/or color information. The target region may be recognized as a wave when a value of the comparison result of the feature information exceeds a preset threshold.

In some exemplary embodiments, the processor may be configured to: calculate a distance from the central position of the target region in the first image to the central position of the target region in the second image. The determining of whether the target region is a wave according to a comparison result of the feature information may include: recognizing the target region as a wave when the distance from the central position of the target region in the first image to the central position of the target region in the second image exceeds a first preset threshold.

In some exemplary embodiments, the processor may be configured to: calculate a first similarity between the grayscale value of the target region in the first image and the grayscale value of the target region in the second image; and recognize the target region as a wave when the first similarity exceeds a second preset threshold.

In some exemplary embodiments, the processor may be configured to analyze a distribution of the grayscale value of the target region by using a grayscale histogram.

In some exemplary embodiments, the processor may further be configured to: determine whether the target region is a water area before the first image acquired by the image acquisition apparatus at the first moment and the second image acquired by the image acquisition apparatus at the second moment are extracted, where the first image acquired by the image acquisition apparatus at the first moment and the second image acquired by the image acquisition apparatus at the second moment are extracted if it is determined that the target region is a water area.

In some exemplary embodiments, the processor may further be configured to: determine whether the target region is moving before the feature information of the target region in the first image is compared with feature information of the target region in the second image, where the feature information of the target region in the first image is compared with feature information of the target region in the second image if it is determined that the target region is moving.

In some exemplary embodiments, the processor may be configured to: determine projection of an edge of the target region in the first image in the second image; calculate a second similarity between the projection and an edge of the target region in the second image; and determine that the target region is moving if the second similarity is greater than a third preset threshold.

In some exemplary embodiments, the processor may be configured to: determine a first coordinate of the edge of the target region in the first image; determine an attitude change of the image acquisition apparatus at the first moment and the second moment; determine a coordinate of the projection according to the first coordinate and the attitude change; and calculate a second similarity between the coordinate of the projection and a coordinate of the edge of the target region in the second image.

In some exemplary embodiments, the processor may be configured to: determine a first attitude of the image acquisition apparatus at the first moment, and a second attitude of the image acquisition apparatus at the second moment; and determine a rotational difference according to a difference between the first attitude and the second attitude.

In some exemplary embodiments, the processor may be configured to: determine a first position of the image acquisition apparatus at the first moment, and a second position of the image acquisition apparatus at the second moment; and determine a positional difference according to a displacement from the first position to the second position.

In some exemplary embodiments, the processor may be configured to: convert the first image into a first binary image, and convert the second image into a second binary image.

In some exemplary embodiments, the first image acquired by the image acquisition apparatus at the first moment may be converted into a first grayscale image, and the second image acquired by the image acquisition apparatus at the second moment may be converted into a second grayscale image; a grayscale value of a pixel that is less than a preset grayscale value in the first grayscale image may be set to zero to obtain a third image, and a grayscale value of a pixel that is less than a preset grayscale value in the second grayscale image may be set to zero to obtain a fourth image; and the third image may be binarized to obtain the first binary image, and the fourth image may be binarized to obtain the second binary image.

In some exemplary embodiments, the processor may further be configured to: extract the target region in the first image by using the first binary image as a mask, and extract the target region in the second image by using the second binary image as a mask.

In some exemplary embodiments, an area of at least one region formed by pixels whose values are the largest in the first binary image may be determined, and an area of at least one region formed by pixels whose values are the largest in the second binary image may be determined; a region whose area is less than a preset area in the region may be deleted from the first binary image to obtain a first sub-image, and a region whose area is less than a preset area in the region may be deleted from the second binary image to obtain a second sub-image; and the target region may be extracted in the first image by using the first sub-image as a mask, and the target region may be extracted in the second image by using the second sub-image as a mask.

In some exemplary embodiments, a difference between the first moment and the second moment may be less than preset duration.

In some exemplary embodiments, the preset duration may be 0.5 second.

In some exemplary embodiments, the processor may further be configured to: calculate a movement speed of the target region when the target region is recognized as a wave.

In some exemplary embodiments, the processor may be configured to: calculate the movement speed of the target region by using an optical flow method.

In some exemplary embodiments, applicable to a UAV, the processor may further be configured to: control movement of the UAV according to the movement speed of the target region.

In some exemplary embodiments, the processor may be configured to: control, according to the movement speed of the target region, the UAV to follow the target region, or to approach the target region, or to move away from the target region.

In some exemplary embodiments, applicable to a UAV, the processor may further be configured to: control the UAV to hover when the target region is recognized as a wave.

In some exemplary embodiments, the processor may be configured to: control the UAV to hover at a current position.

In some exemplary embodiments, applicable to a UAV, the processor may further be configured to: when the target region is recognized as a wave, generate prompt information if the UAV is currently positioned according to an object in an environment, where the prompt information is used to prompt adjustment of a positioning strategy.

In some exemplary embodiments, the adjustment of the positioning strategy may include: prompting the UAV to increase a priority of determining a position according to GPS positioning information.

In some exemplary embodiments, the processor may further be configured to: mark, in multiple to-be-recognized images, multiple wave images in which the target region is recognized as a wave; and synthesize the multiple wave images into a video according to attribute information of the wave images.

In some exemplary embodiments, the attribute information may include at least one of the following: time and location.

The system, apparatus, module, or unit elaborated in the foregoing embodiments may be specifically implemented by a computer chip or an entity, or implemented by a product having a particular function. For ease of description, the foregoing apparatus is described in terms of functions divided into various units. Certainly, during implementation of this application, the functions of the units may be implemented in one or more software and/or hardware. A person skilled in the art should understand that the embodiments of the present disclosure may be provided as a method, a system, or a computer program product. Therefore, the present disclosure may use a form of hardware only embodiments, software only embodiments, or embodiments with a combination of software and hardware. Moreover, the present disclosure may use a form of a computer program product that is implemented on one or more computer-usable storage media (including but not limited to a magnetic disk memory, a CD-ROM, an optical memory, and the like) that include computer-usable program code.

The embodiments of this specification are described in a progressive manner. The same or similar parts between the embodiments may be referred to each other. Each embodiment focuses on differences from other embodiments. Especially, system embodiments are basically similar to a method embodiment, and therefore are described briefly. For related parts, refer to partial descriptions in the method embodiment.

It should be noted that in this specification, relational terms such as first and second are used only to distinguish one entity or operation from another and do not necessarily require or imply any such actual relationship or order between those entities or operations. The term “include”, “contain”, or any other variation thereof is intended to cover a non-exclusive inclusion such that a process, method, article, or device that includes a range of elements includes not only those elements but also other elements that are not expressly listed or that are inherent to such a process, method, article, or device. Without further limitation, an element qualified by the phrase “including a . . . ” does not exclude the presence of an additional identical element in the process, method, article, or device including the element.

The foregoing descriptions are merely the embodiments of this application and are not intended to limit this application. There may be various changes and variations to this application for a person skilled in the art. Any modifications, equivalent replacements, improvements, or the like made within the spirit and principle of this application shall fall within the scope of the claims of this application

What is claimed is:

1. A method for wave recognition, comprising:
extracting, by a processor, a first image acquired by an image acquisition apparatus at a first moment and a second image acquired by the image acquisition apparatus at a second moment;
extracting, by the processor, a target region in each of the first image and the second image;
comparing, by the processor, feature information of the target region in the first image with feature information of the target region in the second image; and
determining, by the processor, whether the target region is a wave according to a result of the comparing.

2. The method according to claim 1, wherein
the feature information includes at least one of position information or color information,
the position information is a central position of the target region,
the comparing of the feature information further includes:
calculating a distance from the central position of the target region in the first image to the central position of the target region in the second image,
the determining of whether the target region is a wave further includes:
recognizing the target region as a wave when the distance from the central position of the target region in the first image to the central position of the target region in the second image exceeds a first preset threshold.

3. The method according to claim 2, wherein
the feature information includes at least one of position information or color information,
the color information is a grayscale value of the target region,
the comparing of the feature information further includes:
calculating a first similarity between a grayscale value of the target region in the first image and a grayscale value of the target region in the second image,
the determining of whether the target region is a wave further includes:
recognizing the target region as a wave when the first similarity exceeds a second preset threshold, and
the method further comprising: analyzing, by the processor, a distribution of the grayscale value of the target region using a grayscale histogram.

4. The method according to claim 1, further comprising:
determining, by the processor, whether the target region is a water area before the extracting of the first image and the second image; and
extracting the first image and the second image after determining that the target region is a water area.

5. The method according to claim 1, further comprising:
determining, by the processor, whether the target region is moving before the comparing of the feature information; and
comparing, by the processor, the feature information of the target region in the first image with the feature information of the target region in the second image after determining that the target region is moving.

6. The method according to claim 5, wherein the determining of whether the target region is moving includes:
determining projection of an edge of the target region in the first image in the second image;
calculating a second similarity between the projection and an edge of the target region in the second image;
determining whether the second similarity is greater than a third preset threshold; and
determining that the target region is moving after determining that the second similarity is greater than a third preset threshold.

7. The method according to claim 6, wherein the calculating of the second similarity includes:
determining a first coordinate of the edge of the target region in the first image;
determining an attitude change of the image acquisition apparatus from the first moment to the second moment;
determining a coordinate of the projection according to the first coordinate and the attitude change; and
calculating the second similarity between the coordinate of the projection and a coordinate of the edge of the target region in the second image.

8. The method according to claim 7, wherein the determining of the attitude change includes:
determining a first attitude of the image acquisition apparatus at the first moment, and a second attitude of the image acquisition apparatus at the second moment; and
determining a rotational difference according to a difference between the first attitude and the second attitude.

9. The method according to claim 7, wherein the determining of the attitude change includes:
determining a first position of the image acquisition apparatus at the first moment, and a second position of the image acquisition apparatus at the second moment; and
determining a positional difference according to a displacement from the first position to the second position.

10. The method according to claim 1, wherein the extracting of the target region in each of the first image and the second image includes:
converting the first image into a first grayscale image;
converting the second image into a second grayscale image;
setting a grayscale value of a pixel that is less than a preset grayscale value in the first grayscale image to zero to obtain a third image;
setting a grayscale value of a pixel that is less than a preset grayscale value in the second grayscale image to zero to obtain a fourth image; and
binarizing the third image to obtain the first binary image, and binarizing the fourth image to obtain the second binary image.

11. The method according to claim 1, wherein the extracting of the target region in each of the first image and the second image includes:
converting the first image into a first binary image, and converting the second image into a second binary image; and
extracting the target region in the first image by using the first binary image as a mask, and extracting the target region in the second image by using the second binary image as a mask.

12. The method according to claim 11, wherein the extracting of the target region in the first image by using the first binary image as a mask and the extracting of the target region in the second image by using the second binary image as a mask includes:
determining an area of at least one region formed by pixels whose values are the largest in the first binary image, and determining an area of at least one region formed by pixels whose values are the largest in the second binary image;
deleting a region whose area is less than a preset area in the region from the first binary image to obtain a first sub-image, and deleting a region whose area is less than a preset area in the region from the second binary image to obtain a second sub-image; and
extracting the target region in the first image by using the first sub-image as a mask, and extracting the target region in the second image by using the second sub-image as a mask.

13. The method according to claim 1, wherein a difference between the first moment and the second moment is less than 0.5 second.

14. The method according to claim 1, further comprising:
calculating, by the processor, a movement speed of the target region by using an optical flow method when the target region is recognized as a wave; and
controlling, by the processor, movement of an unmanned aerial vehicle according to the movement speed.

15. The method according to claim 14, wherein the controlling of the movement of the unmanned aerial vehicle includes:
controlling, according to the movement speed, the unmanned aerial vehicle to follow the target region, or to approach the target region, or to move away from the target region.

16. The method according to claim 1, further comprising:
controlling, by the processor, an unmanned aerial vehicle to hover at a current position when the target region is recognized as a wave.

17. The method according to claim 1, further comprising:
when the target region is recognized as a wave,
determining, by the processor, whether an unmanned aerial vehicle is currently positioned according to an object in an environment; and
after determining the unmanned aerial vehicle is currently positioned according to the object in the environment, generating prompt information to prompt adjustment of a positioning strategy, wherein the adjustment of the positioning strategy includes: prompting the unmanned aerial vehicle to increase a priority of determining a position according to GPS positioning information.

18. The method according to claim 1, further comprising:
marking, by the processor in multiple to-be-recognized images, multiple wave images in which the target region is recognized as a wave; and
synthesizing, by the processor, the multiple wave images into a video according to attribute information of the wave images, wherein the attribute information includes at least one of time or location.

19. A apparatus for wave recognition, comprising:
a processor, configured to:
extract a first image acquired by an image acquisition apparatus at a first moment and a second image acquired by the image acquisition apparatus at a second moment;
extract a target region in each of the first image and the second image;
compare feature information of the target region in the first image with feature information of the target region in the second image; and
determine whether the target region is a wave according to a result of the comparison.

20. An unmanned aerial vehicle, comprising:
a processor, configured to:
extract a first image acquired by an image acquisition apparatus at a first moment and a second image acquired by the image acquisition apparatus at a second moment;
extract a target region in each of the first image and the second image;
compare feature information of the target region in the first image with feature information of the target region in the second image; and
determine whether the target region is a wave according to a result of the comparison.
